(19) United States
(12) Patent Application Publication
(10) Pub. No.: US 2009/0068512 A1
(43) Pub. Date: Mar. 12, 2009

(54) HYDROGEN REFUELING STATION

(76) Inventors: Alexander Gofer, Pompano Beach, FL (US); Konstantin Korytnikov, Hollywood, FL (US)

Correspondence Address: HOWARD & HOWARD ATTORNEYS PLLC, 450 West Fourth Street, Royal Oak, MI, 48067, US

(21) Appl. No.: 12/045,643

(22) Filed: Mar. 10, 2008

Related U.S. Application Data
(60) Provisional application No. 60/893,723, filed on Mar. 8, 2007.

(51) Int. Cl. H01M 8/06

(52) U.S. Cl. 429/20

(57) ABSTRACT

The present invention is a hydrogen refueling station incorporating a fuel cell system serving simultaneously as the power generator and an electrochemical extractor of the pure hydrogen from the hydrogen-rich gas (reformate) produced in steam hydrocarbon reforming process. The hydrogen is stored in a high pressure receiver to be dispensed to vehicles as a fuel. The hydrogen refueling station of the present invention does not require the refilling with DI water.

### RELATED APPLICATIONS

This non-provisional patent application claims priority to a provisional application Ser. No. 60/893,723 filed on Mar. 8, 2007 and incorporated herewith by reference in its entirety.

### FIELD OF THE INVENTION

The subject invention relates to a hydrogen refueling station for hydrogen extraction from the hydrogen-rich gas.

### BACKGROUND OF THE INVENTION

Hydrogen is known as fuel of choice for both the electric power and transportation industries. While it is likely that renewable energy sources will ultimately be used to generate hydrogen, fossil-based technologies will be utilized to generate hydrogen in the near future. Modern hydrogen production is significant and important to number of industries requiring hydrogen produce effluents containing significant amounts of unused hydrogen. The hydrogen requires clean-up before the hydrogen is re-used in other applications. The hydrogen must be separated from other combustion gases, such as carbon dioxide, before it is re-used.

Fuel cells are one of the sources of renewable energy that generate electrical power that can be used in a variety of automotive and non-automotive applications. These fuel cells generate electrical power that can be used in a variety of applications. The fuel cells constructed with proton exchange membranes (PEM fuel cells) may eventually replace the internal combustion engine in motor vehicles. The PEM fuel cells have an ion exchange membrane, which acts as a solid electrolyte, affixed between an anode and a cathode. To produce electricity through electrochemical reactions, hydrogen rich fuel is supplied to the anode and air is supplied to the cathode. An electrochemical reaction between hydrogen and the oxygen contained in the air produces an electrical current, water and heat as reaction products. This water is removed from the cathode.

The ideal fuel for current power generating system based on PEM fuel cells is pure hydrogen. The fuel cell consuming the hydrogen possesses the highest efficiency regarding to other fuel types supplied. By the way the balance of the plant is simplest and smallest in the case if the hydrogen is fed as a fuel which is critical for automotive application of the fuel cell. The major challenge to hydrogen application for the transportation is the refueling infrastructure development. The hydrogen does not exist naturally in the elemental form and, in many applications of PEM fuel cells, is generated by the electrolysis or in hydrocarbon reforming from natural gas, methane, methanol, gasoline and other as the primary fuels through. The electrolysis application consumes significant amount of power, ultimately, requesting the connection to the power grid and the DI water supply.

The hydrocarbon reforming systems typically generate carbon monoxide (CO) as part of the product hydrogen rich gas (typically called the reformate), which poisons the platinum catalyst used on the anode side of the PEM fuel cell and causes considerable drop in the performance. There could be other gaseous by-products such as H₂O, CO₂, N₂, NH₄, H₂S which dilute the hydrogen in the fuel supplied to PEM fuel cells. Considerable effort has been directed toward the method development to selectively filter hydrogen out of reformate.

Prior art is replete with various methods and devices for purifying hydrogen. The U.S. Pat. No. 6,824,593 to Edlund et al. U.S. Pat. No. 6,723,156 to Edlund et al. teach a hydrogen purification membranes, hydrogen purification devices, and fuel processing and fuel cell systems that include hydrogen purification devices. The hydrogen purification membranes include a metal membrane, which is at least substantially comprised of palladium or a palladium alloy. In some embodiments, the membrane contains trace amounts of carbon, silicon, and/or oxygen. In some embodiments, the membranes form part of a hydrogen purification device that includes an enclosure containing a separation assembly, which is adapted to receive a mixed gas stream containing hydrogen gas and to produce a stream that contains pure or at least substantially pure hydrogen gas therefrom. The hydrogen purification devices taught by the aforementioned patents are use a palladium or a palladium alloy membrane, which is highly permeable for hydrogen. In particular, as described in another U.S. Pat. No. 6,569,226 to Dorris et al., a membrane for separating hydrogen from fluids is provided comprising a sintered homogenous mixture of a ceramic composition and a metal. The metal may be palladium, niobium, tantalum, vanadium, or zirconium or a binary mixture of palladium with another metal such as niobium, silver, tantalum, vanadium, or zirconium, which is highly permeable for hydrogen.

The U.S. Pat. No. 6,066,592 to Kawae, et al. discloses a ceramic support coated with palladium or a palladium alloy such as Pd—Ag to serve as a hydrogen separator. The U.S. Pat. No. 5,980,989 to Takahashi, et al. discloses a gas separator membrane in which a metal for separating a gas such as palladium or a palladium alloy is filled into pores opened on the surface of a porous substrate to close them.

Alluding to the above, the United States Patent Application Publication No. 20040142215 to Barbir et al. teaches that hydrogen can be pumped electrochemically across a proton exchange membrane from the reformate stream. The United States Patent Application Publication No. 20040142215 to Barbir et al. fails to suggest expressly or impliedly a method to prevent hydrogen filter anode catalyst from being infiltrated or polluted with carbon monoxide.

There is a constant need for an improved design of a hydrogen purification and reformation systems thereby eliminating problems associated with current prior art methods and systems. Thus, the inventive concept as set forth further below is directed to eliminate one or more problems associated with the prior art methods and systems eliminating problems associated with current designs of prior art designs and methods.

### SUMMARY OF THE INVENTION

The inventive concept relates to a fuel cell system providing internal hydrogen extraction from the hydrogen-rich gas derived from a fuel processing device and the balance of plant which is independent on a power grid. A hydrogen refueling station is based on a fuel cell system fed with the hydrogen-rich fuel received from a steam reformer. The invention also relates to alkaline electrolyte and phosphoric acid fuel cell systems having a proton exchange membrane (PEM) fuel system without limiting the scope of the present invention. The PEM fuel cell system (the fuel cell) includes at least two identical fuel cell sections. Each fuel cell section includes at least one cell comprising a membrane-electrode-assembly including a proton-exchange membrane, primary and hydrogen electrodes disposed on opposite sides of the proton-exchange membrane.

At least one primary electrode faces to a primary flow field with an inlet adjacent to a primary manifold of the fuel cell section. An outlet is adjacent to an exhaust manifold of the fuel cell section. At least one hydrogen electrode faces a hydrogen flow field with an inlet adjacent to a hydrogen manifold of the fuel cell and with an outlet adjacent to a hydrogen exhaust manifold of the fuel cell. The fuel cell operated between several modes. One of the modes as will be described in details below. The hydrogen-rich fuel is produced in the reformer as a product of a water-gas shift reaction between a hydrocarbon and water. It is supplied to the primary manifold of the fuel cell section which operates in the hydrogen filtering mode. Due to the current applied the fuel cell section operating under the hydrogen pump effect wherein the hydrogen contained in the reformate dissociates into electrons and hydrogen ions at the primary electrode or as the anode, the hydrogen ions pass through the electrolyte to the hydrogen electrode, and the electrons flow to the hydrogen electrode to produce H₂ which is collected in a hydrogen manifold which is common for the fuel cell system.

Alluding to the above, the hydrogen from the hydrogen manifold is pumped by a hydrogen compressor at a high pressure into a receiver to be further distributed into fuel tanks of vehicles. A gas flow rejected from the exhaust manifold the fuel cell section may contain high concentration of CO. There are some reasons to supply the primary exhaust back to a reformer: hydrogen remains and CO can be oxidized to produce heat for fuel processing; CO is converted to CO₂ and is eliminated as the hazardous gas to humans.

In a power generation mode of the hydrogen refueling station, the oxygen-rich gas, mainly air, as oxidant, is supplied by the compressor to the fuel cell power generating section through its primary manifold and pure hydrogen, as a fuel, is consumed on the hydrogen electrodes from the common hydrogen manifold. Polluting a catalyst with carbon monoxide contained in the hydrogen-rich fuel causes the performance deterioration of the fuel cell section operating in the hydrogen filtering mode. At a pre-defined level of the performance deterioration, such as the critical increase in the voltage, the critical ratio between the power provided to the fuel cell section and the power generated by the fuel cell system, the fuel cell section is switched to the power generating mode.

Simultaneously another fuel cell section is switched from the power generating mode to the hydrogen filtering mode. Carbon monoxide absorbed on the primary electrode catalyst of the fuel cell section switched to the power generating mode is oxidized to carbon dioxide due to the introduction of air to the primary electrodes, now acting as cathodes.

An cathode exhaust rejected from the exhaust manifold of the fuel cell section being in the power generating mode. Initially, the cathode exhaust is supplied to a humidifier wherein some moisture from the cathode exhaust is transferred to the oxygen-rich gas intended for feeding the section. Then, the cathode exhaust pre-cooled in a heat exchanger is directed to a water trap wherein water condensate is discharged to a water tank to be used as a reactant for the water-gas shift reaction in the reformer. The combustion exhaust is also processed consequently in a heat exchanger and a water trap to donate the water into the water tank. Total water amount collected is supposed to be equal to water used for the reformate production and makes the hydrogen refueling station independent on any external DI water supply.

A system exhaust combining the cathode exhaust exiting the water tank and a hot combustion exhaust from the reformer burner is introduced to a turbo generator at elevated temperature wherein there is the conversion of the flow energy into the electrical power. The system exhaust contains the nitrogen, moisture and carbon dioxide and is environmental friendly. The power derived from the fuel cell section being in the power generating mode and the turbo generator covers the total power consumption of the hydrogen refueling station.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 illustrates a schematic view of a hydrogen refueling station of the present invention; and

FIG. 2 is a schematic view illustrating the effect of the hydrogen pump upon the application of the hydrogen refueling station of the present invention.

### DETAILED DESCRIPTION OF THE PREFERRED EMBODIMENT

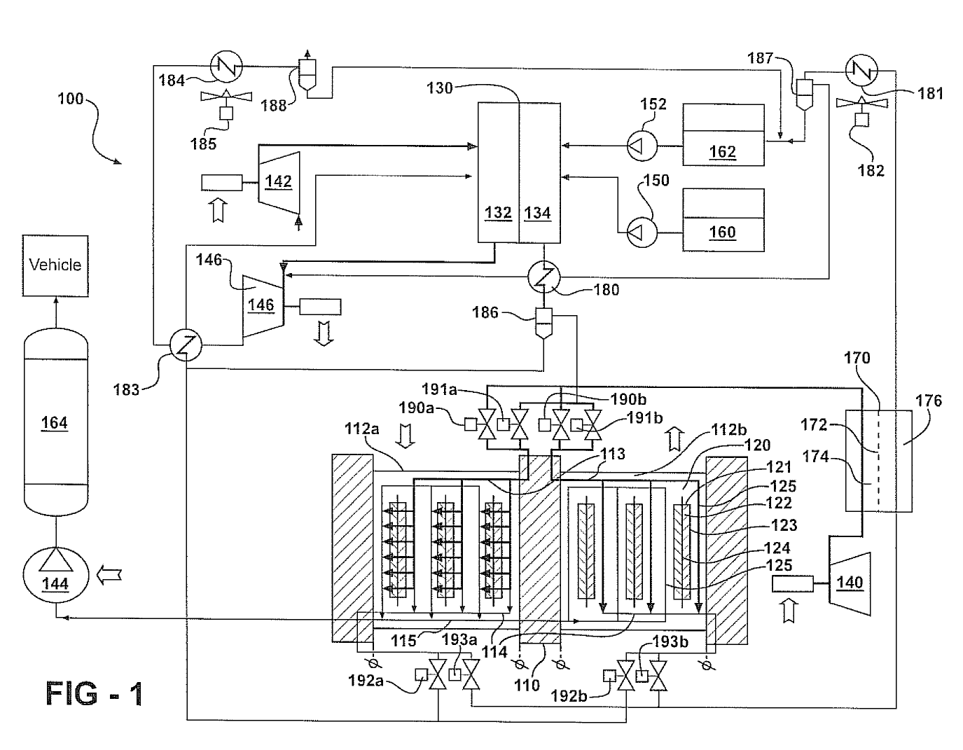

Referring to the Figures, wherein like numerals indicate like or corresponding parts, a first embodiment of a hydrogen refueling station is shown in FIG. 1 and is generally designated by the reference numeral 100. The hydrogen refueling station 100 includes a fuel cell stack 110, a primary fuel reformer 130 comprising an internal burner 132 and a converter 134, a fuel cell air compressor 140, a reformer air compressor 142, a high pressure hydrogen compressor 144. The hydrogen refueling station 100 includes a turbo generator 146, a primary fuel pump 150, a water pump 152, a primary fuel tank 160, a water tank 162, a high pressure receiver 164, a humidifier 170 separated with a moisture permeable membrane 172 into an air feed compartment 174 and an air exhaust compartment 176. The hydrogen refueling station 100 also includes an reformat heat exchanger 180, an air exhaust heat exchanger 181 having a blower 182 as cooling means, a reformate exhaust heat exchanger 183. The hydrogen refueling station 100 includes a system exhaust heat exchanger 184 having a blower 185 as cooling means; a reformate liquid trap 186; a air exhaust liquid trap 187; a system exhaust liquid trap 188; solenoid valves 190a-193a and 190b-193b.

The fuel cell stack 110 includes fuel cell sections 112a and 112b. Each fuel cell section 112a and 112b includes at least one cell 120. Each cell 120 includes a membrane-electrode-assembly 121 combining a proton-exchange membrane 122, two electrodes disposed on opposite sides of the membrane 122. A primary electrode 123 of each cell 120 faces a primary flow field 125 with an inlet adjacent to a primary manifold 113 of the fuel cell section 112a or 112b and with an outlet adjacent to an exhaust manifold 114 of the fuel cell section 112a or 112b. Each cell 120 also includes a hydrogen electrode 124 faces a hydrogen flow field 126 adjacent to a hydrogen manifold 115 of the fuel cell stack 110. The primary manifold 113 of the fuel cell sections 112a and 112b is secured, consequently, solenoid valves 190a, 190b and 191a, 191b. The exhaust manifold 114 of the fuel cell sections 112a and 112b is secured, consequently, solenoid valves 192a, 192b and 193a, 193b. The primary manifold 113 of the fuel cell section 112a (112b) is in fluid communication either with an outlet of the converter 134 of the primary fuel reformer 130 through a gas side of the reformate liquid trap and the reformate heat exchanger by means of the solenoid valve 190a (190b) open or with the fuel cell air compressor 140 through the air feed compartment 174 of the humidifier 170 by means of the solenoid valve 191a (191b) open.

The exhaust manifold 114 of fuel cell section 112a (112b) is in fluid communication either with an inlet of the internal burner 132 of the primary fuel reformer 130 through the reformate exhaust heat exchanger 183 by means of the solenoid valve 192a (192b) open or with an inlet of the turbo generator 146, consequently, through the air exhaust compartment 176 of the humidifier 170, the air exhaust heat exchanger 181, a gas side of the air exhaust liquid trap 187 and the reformate heat exchanger 180 by means of solenoid valve 193a (193b) open. The hydrogen manifold 115 of the fuel cell stack 110 is in fluid communication with the high pressure receiver 164 by means of the high pressure hydrogen compressor 144.

Also the primary fuel reformer 130 has other fluid communications: an inlet of the converter 134 is in fluid communication with the primary fuel tank 160 by means of the primary fuel pump 150 and with the water tank 162 by means of the water pump 152, an inlet of the internal burner 132 of the primary fuel reformer is in fluid communication with the reformer air compressor 142, an outlet of the internal burner 132 of the primary fuel reformer is in fluid communication with the inlet of the turbo generator 146.

An outlet of the turbo generator 146 is in fluid communication with a gas side of the system exhaust liquid trap 188 through the reformate exhaust heat exchanger 183 and the system exhaust heat exchanger 184. A liquid side of reformate liquid trap 186 is adjusted to the fluid communication of the inlet of the internal burner 132 of the primary fuel reformer 130 with the exhaust manifold 114 of fuel cell section 112a (112b) in a section between the reformate exhaust heat exchanger 183 and the solenoid valve 192a (192b). Liquid sides of the air exhaust liquid trap 187 and the system exhaust liquid trap 188 are in fluid communication with the water tank.

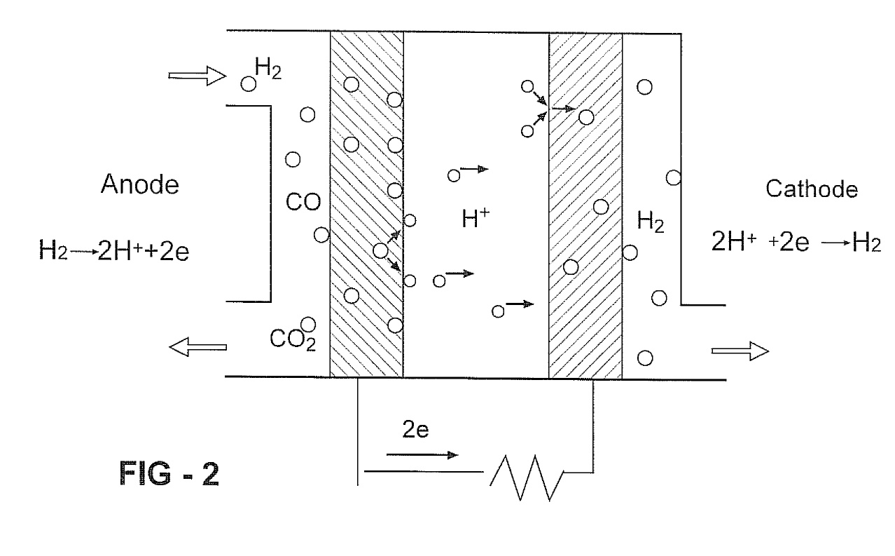

As shown in FIG. 1, a hydrogen filtering mode operates in hydrogen filtering mode whereby the reformate is introduced from the outlet of the converter 134 of the primary fuel reformer 130 to the primary manifold 113 of fuel cell section 112a and, then, through the primary flow fields 125 to the primary electrodes 123 as the solenoid valve 191a is moved between an opened position and a closed position. The reformate exhaust is then rejected from the exhaust manifold 114 of the fuel cell section 112a as the solenoid valve 191a is moved between the opened position and the closed position. The current is applied to the fuel cell section 112a forcing a major portion of the hydrogen contained in the reformate to electrochemically pass from the primary electrodes 123 to the hydrogen electrodes 124, as shown in FIG. 2, and, then, through the hydrogen flow fields 126 to the hydrogen manifold 115 of the fuel cell stack 110.

When the fuel cell stack 110 is in a power generating mode, the air as oxygen containing gas is introduced by the fuel cell air compressor 140 to the primary manifold 113 of the fuel cell section 112b and, then through the primary flow fields 125 to the primary electrodes 123 by as the solenoid valve 191a is moved between the opened position and the closed position. The minor portion of hydrogen delivered to the hydrogen manifold 115 of the fuel cell stack 110 by means of the fuel cell section 112a being in the hydrogen filtering mode is fed to the hydrogen electrodes 124 of the fuel cell section 112b through the hydrogen flow fields 126 as a fuel. The air exhaust is rejected from the exhaust manifold 114 of the fuel cell section 112b by as the solenoid valve 191a is moved between the opened position and the closed position. The current generated by the fuel cell section 112b covers the main power demand of the hydrogen refueling station 100.

Alluding to the above, the major portion of hydrogen delivered to the hydrogen manifold 115 of the fuel cell stack 110 is pumped by the high pressure hydrogen compressor 144 into high pressure receiver 164 wherefrom the hydrogen is dispensed to vehicles. The converter 134 of the primary fuel reformer 130 is fed with a primary fuel and water as reagents for the hydrogen-rich fuel generation proportionally delivered to the inlet of the converter 134, consequently, by the primary fuel pump 150 from the primary fuel tank 160 and by means of the water pump 152 from the water tank 162. The reformate delivered from the outlet of the converter 134 of the primary fuel reformer 130 to the fuel cell section 112a being in the hydrogen filtering mode as a source of the hydrogen, first, is pre-cooled in the reformate heat exchanger 180 to make its thermal condition acceptable for the fuel cell operation, then, passes through the gas side of the reformate liquid trap 186 wherefrom a reformate condensate is withdrawn from the reformate to the liquid side of the reformate liquid trap 186 in order to prevent the flooding of fuel cell section 112a.

The reformate condensate is discharged from the liquid side of the reformate liquid trap 186 into the reformate exhaust stream. The internal burner 132 of the primary fuel reformer 130 is fed with a fuel which is, first, the hydrogen containing in the reformate exhaust, second, some carbon monoxide containing in the reformate exhaust, third, the primary fuel containing in the reformate condensate diverted from the reformate in the reformate liquid trap 186 with a oxidant as the oxygen containing in the air delivered by the reformer air compressor 142, first, to generate a heat to maintain the reformate generation in the converter 134 of the primary fuel reformer 130.

The air exhaust is delivered from the exhaust manifold 114 of the fuel cell section 112b being in the power generating mode, first, to the air exhaust compartment 176 of the humidifier 170 wherefrom some moisture and some heat of the air exhaust is transferred through the moisture permeable membrane 172 to the air flowing across the air feed compartment 174 in order to humidify the air in according with the proper operation requirement for the fuel cell section 112b and to pre-cool the air exhaust, second, to the air exhaust heat exchanger 181 wherein some moisture from the air exhaust is condensed by means of a cooling flow provided by the blower 182, third, through the gas side of the air exhaust liquid trap 186 wherefrom a water condensate is withdrawn from the air exhaust to the liquid side of the reformate liquid trap 186, fourth, through the reformate heat exchanger 180 to be pre-heated before the introduction into the turbo generator 146, fifth, to the inlet of the turbo generator 146.

A combustion exhaust from the outlet of internal burner 132 of the primary fuel reformer 130 is supplied to the inlet of the turbo generator 146. Under the hydrogen refueling station operation a system exhaust created at the inlet of the turbo generator 146 by mixture of the combustion exhaust and the air exhaust is delivered at elevated temperature to the turbo generator 146 wherein the flow energy is converted into the electrical power to partly cover the power demand of the hydrogen refueling station 100.

The system exhaust from the outlet of the turbo generator 146 is delivered, to reformate exhaust heat exchanger 183 be pre-cooled and then to the system exhaust heat exchanger 184 wherein some moisture from the system exhaust is condensed by a cooling flow provided by the blower 185. The gas side of the air exhaust liquid trap 188 wherefrom a water condensate is withdrawn from the system exhaust to the liquid side of the system exhaust liquid trap 188. The water from the liquid sides of the air exhaust liquid trap 186 and the air exhaust liquid trap 188 is delivered into the water tank 162.

Water balance in the water tank 162 is controlled by the blower 182 and 185 maintaining the proper cooling flows through the air exhaust heat exchanger 181 and the system exhaust heat exchanger 184 in order to recover a proper water amount. In event of performance degradation of the fuel cell section 112a being in the hydrogen filtering mode due to a primary catalyst poisoning is switched to the power generating mode by changing a) the position of the solenoid valves (190a, 193a are open; 191a, 192a are closed) b) the electrical connection for the power generation; simultaneously the fuel cell section 112b being in the power generating mode is switched to the hydrogen filtering mode by changing a) the position of the solenoid valves (191b, 192b are open; 190b, 193b are closed) b) the electrical connection for the power consumption. Based on the usage of the methanol as a primary fuel the major parameters of the hydrogen refueling station producing pure hydrogen as much 6,000,000 L per a week are how they are shown in FIG. 1.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A hydrogen refueling station for internal hydrogen extraction from the hydrogen-rich gas derived from a fuel processing device, said hydrogen refueling station comprising:
at least one fuel reformer having at least one heating element;
a converter for reacting fuel and water thereby generating hydrogen-rich fuel;
a fuel cell system presenting at least a hydrogen manifold, at least first and second sections with each said first and second sections having at least one cell with a proton-exchange membrane, primary electrodes and hydrogen electrodes disposed on opposite sides of said proton-exchange membrane, and
said first and second sections of said fuel cell system selectively operable between a hydrogen filtering mode as in at least one of said first and second sections the hydrogen is dissociated into electrons and hydrogen ions at said primary electrode of said at least one fuel cell of at least one of said first and second sections with the hydrogen ions passing to said hydrogen electrode of said at least one fuel cell with the electrons flown to said hydrogen electrode to produce H₂ collected in said hydrogen manifold and a power generation mode whereby in at least one of said first and second sections the oxygen-rich fluid is supplied to at least one of said first and second sections through said primary manifold whereby pure hydrogen is consumed on said hydrogen electrodes of at least one of said first and second sections.

2. A hydrogen refueling station as set forth in claim 1 wherein each cell includes a primary flow field facing to said primary electrode with an inlet adjacent said primary manifold of one of said first and second sections and with an outlet adjacent an exhaust manifold of one of said first and second section, a hydrogen flow field facing to said hydrogen electrode adjacent said hydrogen manifold, a fuel feed valve securing said primary manifold, an air feed valve securing said primary manifold, a fuel exhaust valve securing said exhaust manifold, a air exhaust valve securing said exhaust manifold.

3. A hydrogen refueling station as set forth in claim 2 including a fuel cell air compressor, a humidifier containing an air feed compartment and an air exhaust compartment, a primary fuel pump, a primary fuel tank, a water pump, a water tank, a reformer air compressor, a turbo generator, a high pressure hydrogen compressor; a high pressure receiver, an hydrogen-rich fuel heat exchanger, an air exhaust heat exchanger, a fuel exhaust heat exchanger, an system exhaust heat exchanger, an hydrogen-rich fuel liquid trap, an air exhaust liquid trap, and an system exhaust liquid trap.

4. A hydrogen refueling station as set forth in claim 3 wherein said primary manifold of each said first and second sections is fluid communicated either with an outlet of said converter of said fuel reformer through a gas side of said hydrogen-rich fuel liquid trap and said hydrogen-rich fuel heat exchanger by means of said fuel feed valve open or with said fuel cell air compressor through said air feed compartment of said humidifier by means of said air feed valve open.

5. A hydrogen refueling station as set forth in claim 1 wherein the water from said liquid sides of said air exhaust liquid trap and said air exhaust liquid trap is discharged into said water tank to cover water demand for the hydrogen-rich fuel generation in said converter of said primary fuel reformer.
